(19) United States
(12) Patent Application Publication
(10) Pub. No.: US 2017/0017051 A1
(43) Pub. Date: Jan. 19, 2017

(54) LENS HOLDING STRUCTURE, LENS HOLDER, OPTICAL MODULE AND LENS HOLDING METHOD

(71) Applicant: NEC CORPORATION, Tokyo (JP)

(72) Inventors: Taro KANEKO, Tokyo (JP); Junichi SASAKI, Tokyo (JP)

(73) Assignee: NEC Corporation, Tokyo (JP)

(21) Appl. No.: 15/121,333

(22) PCT Filed: Feb. 10, 2015
(86) PCT No.: PCT/JP2015/000606

§ 371 Date: Aug. 24, 2016

(30) Foreign Application Priority Data
Feb. 26, 2014 (JP) 2014-035342

(51) Int. Cl. G02B 6/42; G02B 3/00; G02B 6/32

(52) U.S. Cl. CPC G02B 6/4244; G02B 6/32; G02B 6/4239; G02B 6/4206; G02B 6/4213; G02B 3/0075

(57) ABSTRACT

In order to alleviate constraints on the structural design of an optical module internally provided with a lens array, a lens holding structure of the present invention includes, with respect to a lens array including a plurality of lenses each having a convex surface, optical axes of the lenses being disposed in parallel to each other, the lenses being arranged in such a manner that an apex of the convex surface of each lens is included in a predetermined plane perpendicular to the optical axes of the lenses, one surface which is brought into close contact with the convex surfaces of the lenses; and another surface which fixes a side surface of the lens array.

### TECHNICAL FIELD

The present invention relates to a lens holding structure, a lens holder, an optical module, and a lens holding method, and more particularly to a lens holding structure, a lens holder, an optical module, and a lens holding method using a lens array as a lens.

### BACKGROUND ART

In recent years, an optical communication system is widely used in a trunk line system such as Dense-Wavelength Division Multiplex (D-WDM), a subscriber system such as a Fiber To The Home (FTTH), and the like. As the optical communication system is widely used, a demand for optical transmission/optical receiving/optical functional modules or the like for use in the optical communication system increases. Further, as a high-speed and large-capacity optical communication system develops, a demand for integration of these optical modules increases.

Miniaturization and integration of optical components constituting an optical module are conceived to be effective with respect to the demand increase or the demand for high integration. In particular, optical components such as lenses or optical fibers can be integrated with high-density by an array configuration. Therefore, it is possible to apply this technique to an optical module by bundling a plurality of communication lines. If optical components are manufactured with use of a wafer process, for instance, the number of components to be obtained per wafer increases by miniaturization and integration of optical components. There is known, as a method for manufacturing arrayed lenses using a wafer process, a method in which lenses arranged on the entire surface of a wafer by an etching process are manufactured, and lenses of a required number are cut out from the two-dimensionally arranged lenses.

PTL 1 describes a related art using a lens array. PTL 1 describes a configuration, in which a first structure is formed on a surface of a light emitting element, and a second structure that matches with the first structure is formed on an optical element. PTL 1 describes an optical module configured such that the light emitting element and the optical element are positioned with a gap of about several μm by engagement of the first structure and the second structure.

### CITATION LIST

### Patent Literature

[PTL 1] Japanese Laid-open Patent Publication No. 2005-99069

[PTL 2] Japanese Laid-open Patent Publication No. 2006-512598

[PTL 3] Japanese Laid-open Patent Publication No. H11-23805

[PTL 4] Japanese Laid-open Patent Publication No. H10-225995

### SUMMARY OF INVENTION

### Technical Problem

However, the related art described in PTL 1 is based on the premise that optical axes of lenses are aligned with a vertical direction.

Therefore, in the related art described in PTL 1, the structures are placed one over the other in the gravitational direction. This causes a problem that it is difficult to hold a lens array when an optical module is inclined by 90°. Further, it is necessary to additionally form a structure on one surface of a lens array by a unique method. As described above, the structural design of an optical module using an integrated component such as a lens array is constrained.

An object of the present invention is to provide a lens holding structure, a lens holder, an optical module, and a lens holding method that enable to alleviate constraints on the structural design of an optical module.

### Solution to Problem

A lens holding structure of the present invention includes, with respect to a lens array including a plurality of lenses each having a convex surface, optical axes of the lenses being disposed in parallel to each other, the lenses being arranged in such a manner that an apex of the convex surface of each lens is included in a predetermined plane perpendicular to the optical axes of the lenses, one surface which is brought into close contact with the convex surfaces of the lenses; and another surface which fixes a side surface of the lens array.

A lens holder of the present invention includes the lens holding structure and a lens array.

An optical module of the present invention includes the lens holder; an optical fiber which outputs or receives an optical signal; and an optical element which outputs or receives the optical signal, wherein the optical fiber and the optical element are optically connected by using the lens holder.

A lens holding method according to the present invention includes, with respect to a lens array including a plurality of lenses each having a convex surface, optical axes of the lenses being disposed in parallel to each other, the lenses being arranged in such a manner that an apex of the convex surface of each lens is included in a predetermined plane perpendicular to the optical axes of the lenses, making close contact with the convex surfaces of the lenses; and fixing a side surface of the lens array.

### Advantageous Effects of Invention

According to the lens holding structure, the lens holder, the optical module, and the lens holding method of the present invention, it is possible to alleviate constraints on the structural design of the optical module.

### BRIEF DESCRIPTION OF DRAWINGS

FIG. 1A is a side view illustrating a configuration of a lens holder according to a first exemplary embodiment of the present invention;

FIG. 1B is a front view illustrating the configuration of the lens holder according to the first exemplary embodiment of the present invention;

FIG. 2A is a side view illustrating a configuration of a lens holder according to a second exemplary embodiment of the present invention;

FIG. 2B is a front view illustrating the configuration of the lens holder according to the second exemplary embodiment of the present invention;

FIG. 3 is a side view illustrating a configuration of a lens holder according to a third exemplary embodiment of the present invention;

FIG. 4A is a side view illustrating a configuration of a lens holder according to a fourth exemplary embodiment of the present invention;

FIG. 4B is a front view illustrating the configuration of the lens holder according to the fourth exemplary embodiment of the present invention;

FIG. 5 is a diagram illustrating a configuration of a lens holder according to a fifth exemplary embodiment of the present invention;

FIG. 6 is a side view illustrating a configuration of a lens holder according to a sixth exemplary embodiment of the present invention;

FIG. 7 is a diagram illustrating a configuration of an optical module according to a seventh exemplary embodiment of the present invention; and

FIG. 8 is a diagram illustrating a structure of a lens holder of a related art.

### DESCRIPTION OF EMBODIMENTS

In the following, exemplary embodiments of the present invention are described in details referring to the drawings.

Note that in the following description, elements having the same functions as each other are indicated by the same reference numerals, and repeated description thereof may be omitted.

### First Exemplary Embodiment

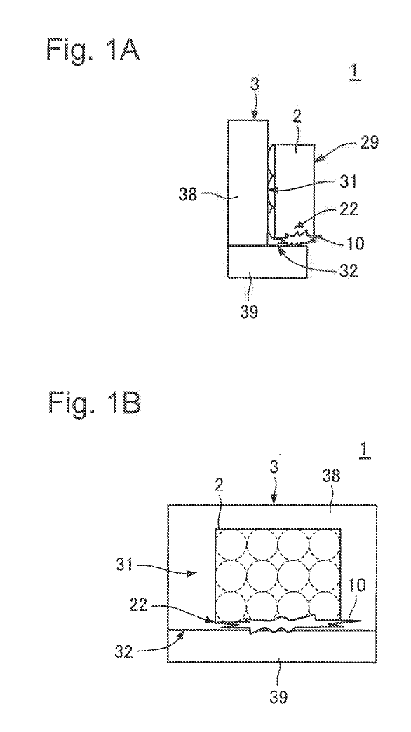

FIG. 1A is a side view illustrating a configuration of a first exemplary embodiment of the present invention. FIG. 1B is a front view illustrating the configuration of the first exemplary embodiment of the present invention. A plano-convex lens array 2 includes a plurality of lenses each having a convex surface. In the plano-convex lens array 2, optical axes of the lenses are disposed in parallel to each other. Further, the plano-convex lens array 2 is disposed in such a manner that the apex of the convex surface of each lens is included in a predetermined plane perpendicular to the optical axes of the lenses. A lens holding structure 3 includes a connection member 38 having one surface 31, and an adhesive member 39 having another surface 32. A lens holder 1 includes the plano-convex lens array 2 and the lens holding structure 3. The plano-convex lens array 2 and the lens holding structure 3 are respectively held by a mounting device such as a jig, and positions of the plano-convex lens array 2 and the lens holding structure 3 are adjusted so that the optical axes are aligned to each other. The adjustment is performed by using mechanical precision of a reference plane of the connection member 38, or by checking adjustment/disposition through an enlarged image. After the positions of the plano-convex lens array 2 and the lens holding structure 3 are adjusted to optimum positions, the plano-convex lens array 2 and the lens holding structure 3 are brought into pressing contact with each other. After the pressing contact, a UV curable adhesive agent is allowed to flow between a side surface 22 of the plano-convex lens array 2 and the other surface 32 of the adhesive member 39. Then, ultraviolet light is irradiated in the pressing contact state to cure the adhesive agent. By the aforementioned process, the plano-convex lens array 2 and the lens holding structure 3 are fixed at the aforementioned adjusted position. The lens holder 1 is configured in such a manner that the side surface 22 of the plano-convex lens array 2 is fixed to the other surface 32 of the adhesive member 39 in a state that the convex surfaces of the plano-convex lens array 2 are in close contact with the one surface 31 of the connection member 38. In this way, in the lens holder 1, the plano-convex lens array 2 is joined to the lens holding structure 3 by using the convex surfaces of the plano-convex lens array 2, instead of a flat surface 29 of the plano-convex lens array 2. Note that in order to transmit light through the one surface 31 of the connection member 38, the connection member 38 having the one surface 31 is made of a light transmissive material. Light transmission loss can be reduced by applying optical polishing, non-reflective coating, or the like to a portion on the one surface 31, which serves as an optical path. Further, as a method for manufacturing the lens holding structure 3, the connection member 38 having the one surface 31, and the adhesive member 39 having the other surface 32 may be manufactured as individual components and then assembled to each other, or may be integrally molded by using a same material. As described above, the lens holder 1 of the exemplary embodiment can alleviate constraints on the structural design of an optical module. Note that in the lens holder 1 of the exemplary embodiment, surfaces to be used are differentiated such that positional adjustment of the plano-convex lens array 2 is performed on the one surface 31 of the connection member 38, and fixation is performed on the other surface 32 of the adhesive member 39. Thus, constraints are also alleviated in a method for manufacturing the lens holder 1 of the exemplary embodiment.

Subsequently, advantageous effects of the present application are further described by comparison with a related art. FIG. 8 is a diagram illustrating a structure of a lens holder of a related art. The lens holder of a related art has a structure such that a flat surface portion of a plano-convex lens array 2 is attached to one surface 9a of a plate member 9. The plano-convex lens array 2 is a lens array, in which a plurality lenses each having a convex surface are disposed in such a manner that the convex surfaces of the lenses are aligned with a direction orthogonal to the optical axes of the lenses. Generally, in a plano-convex lens array, light is collected on a portion having a convex shape. The lens holder of a related art has the thickness of the plano-convex lens array 2 itself and the thickness of the plate member 9 on the right side of a portion having convex shapes in FIG. 8. Therefore, it is difficult to apply the lens holder to an optical system in which the focus position does not reach the right side of the plate member 9 in FIG. 8. On the other hand, the lens holder 1 of the exemplary embodiment has the thickness of the connection member 38 on the left side of a portion having convex shapes in FIG. 1A, and the thickness of the plano-convex lens array 2 itself on the right side of the portion having convex shapes in FIG. 1A. This makes it possible to prevent thickness deviation to one side of a portion having convex shapes. Thus, the lens holder 1 of the exemplary embodiment is advantageously used in an optical system having a short focal length, as compared with the lens holder of a related art. This makes it possible to alleviate constraints on the structural design of an optical module. Note that in the configuration of the lens holding structure of a related art, positional adjustment and fixation of the plano-convex lens array 2 are performed on a same surface in attaching a flat surface portion of the plano-convex lens array 2 to the plate member 9.

### Second Exemplary Embodiment

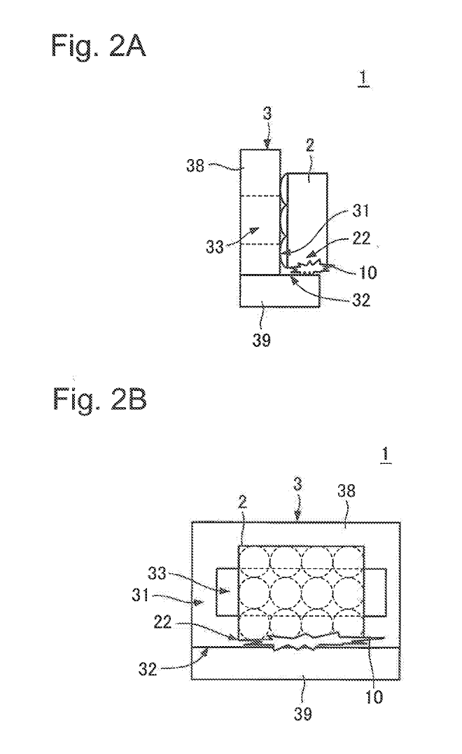

FIG. 2A is a side view illustrating a configuration of a second exemplary embodiment of the present invention. FIG. 2B is a front view illustrating the configuration of the second exemplary embodiment of the present invention. The configuration of the second exemplary embodiment illustrated in FIG. 2A and FIG. 2B is different from the configuration of the first exemplary embodiment illustrated in FIG. 1A and FIG. 1B in a point that a through-hole is formed in a connection member 38. In the exemplary embodiment, a portion where the through-hole is formed is a hole portion 33. The other configuration is the same as the configuration illustrated in FIG. 1A and FIG. 1B. As described above, in the exemplary embodiment, the hole portion 33 is formed in the connection member 38 having one surface 31. Therefore, an optical path is not blocked no matter what kind of material is used for the connection member 38 having the one surface 31. Thus, it is possible to use a light non-transmissive material for a lens holder. Specifically, constraints on the material of the connection member 38 are alleviated. For instance, it is possible to use alumina (linear expansion coefficient: 7.2×10⁻⁶/° C.), which is ceramic that does not transmit light, as a material for a lens holder in the case where a plano-convex lens array 2 uses an optical glass material BK7 (linear expansion coefficient: 7.1×10⁻⁶/° C.). Note that alumina and BK7 have linear expansion coefficients approximately equal to each other. Therefore, even when the ambient temperature changes, it is possible to suppress generation of thermal stress on adhesive surfaces of the lens array 2 and a lens holding structure 3. Further, alumina is less likely to chip, as compared with glass. Therefore, it is easy to handle a lens holder 1 in gripping the lens holder 1 with tweezers or a like tool at the time of assembling an optical module. In other words, constraints on handling components are alleviated.

### Advantageous Effects

According to the lens holding structure, the lens holder, the optical module, and the lens holding method of the exemplary embodiment, it is possible to alleviate constraints on the structural design of the optical module.

Further, in the exemplary embodiment, it is possible to use a light non-transmissive material as a material for the lens holder. This is advantageous in widening the material selection range.

### Third Exemplary Embodiment

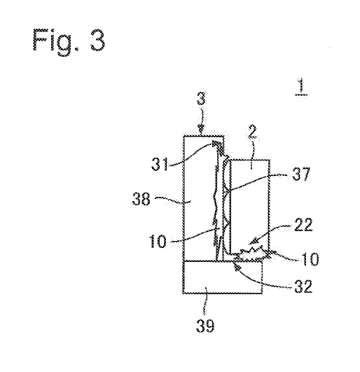

FIG. 3 is a diagram illustrating a configuration of a third exemplary embodiment of the present invention. A difference between the configuration of the third exemplary embodiment illustrated in FIG. 3, and the configuration of the first exemplary embodiment illustrated in FIG. 1 resides in one surface 31 of a connection member 38. The other configuration is the same as the configuration illustrated in FIG. 1. Specifically, the third exemplary embodiment has a structure, in which convex surfaces of a plano-convex lens array 2 are adhered to the one surface 31 of the connection member 38. The plano-convex lens array 2 and a lens holding structure 3 are respectively held by a mounting device such as a jig. An adhesive agent 10, which is a UV curable adhesive agent, is coated on the convex surfaces of the plano-convex lens array 2 or on the one surface 31. After the coating, positions of the plano-convex lens array 2 and the lens holding structure 3 are adjusted so that optical axes are aligned to each other. After the adjustment, the convex surfaces of the plano-convex lens array 2 and the one surface 31 of the connection member 38 are brought into pressing contact with each other. Then, ultraviolet light is irradiated onto the one surface 31 to cure the adhesive agent 10. For reinforcement, the adhesive agent 10 is allowed to flow between a side surface 22 of the plano-convex lens array 2 and another surface 32 of a lens holder. Then, ultraviolet light is irradiated to cure the adhesive agent 10.

### Advantageous Effects

According to the lens holding structure, the lens holder, the optical module, and the lens holding method of the exemplary embodiment, it is possible to alleviate constraints on the structural design of the optical module.

Further, in the exemplary embodiment, when a surface coated with the adhesive agent 10 is the one surface 31, the adhesive agent 10 exists in a gap 37 between the one surface 31 and the convex surfaces of the plano-convex lens array 2. This avoids dripping of adhesive agent with the lapse of time, as compared with a configuration, in which the adhesive agent 10 exists between planes, for instance. Further, when the positions of the plano-convex lens array 2 and the lens holding structure 3 are fixed by curing of an adhesive agent from the beginning, it is not necessary to fix the components thereafter. This makes it possible to use a thermosetting adhesive agent whose curing time is long, as an adhesive agent for use in reinforcement. This is advantageous in widening the material selection range.

### Fourth Exemplary Embodiment

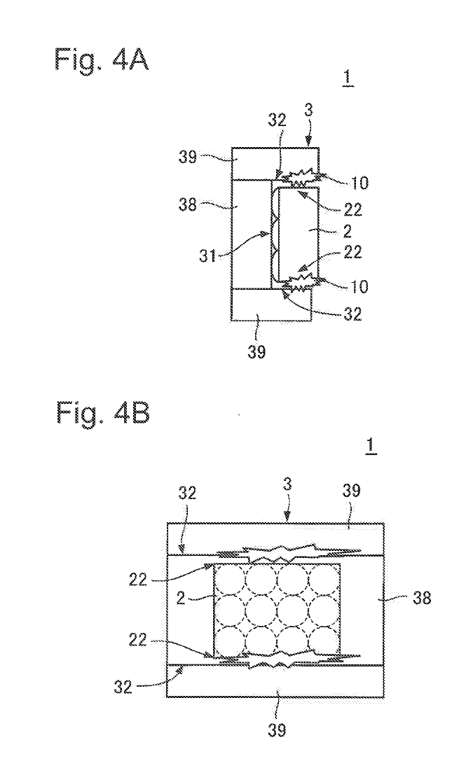

FIG. 4A is a side view illustrating a configuration of a fourth exemplary embodiment of the present invention. FIG. 4B is a front view illustrating the configuration of the fourth exemplary embodiment of the present invention. A difference between the configuration of the fourth exemplary embodiment illustrated in FIG. 4A and FIG. 4B, and the configuration of the first exemplary embodiment illustrated in FIG. 1A and FIG. 1B resides in another surfaces 32 of adhesive members 39. The other configuration is the same as the configuration illustrated in FIG. 1. Specifically, the fourth exemplary embodiment has a structure, in which each of two side surfaces 22 of a plano-convex lens array 2 is adhesively fixed to the corresponding another surface 32 of the adhesive member 39 in a state that convex surfaces of the plano-convex lens array 2 are in close contact with a connection member 38. Adhesion at two positions makes it possible to increase the adhesion area. This leads to an increase in the adhesion force. Further, even when curing shrinkage occurs in curing an adhesive agent 10, it is possible to offset stress caused by curing of the adhesive agent 10 because the plano-convex lens array 2 adheres to the adhesion members 39 at two surfaces facing each other. Thus, in the exemplary embodiment, it is possible to prevent positional deviation of the plano-convex lens array 2. Note that surfaces to be adhered are not limited to two surfaces. The plano-convex lens array 2 may be fixed at three or more surfaces.

### Advantageous Effects

According to the lens holding structure, the lens holder, the optical module, and the lens holding method of the exemplary embodiment, it is possible to alleviate constraints on the structural design of the optical module.

Further, in the exemplary embodiment, the adhesive force increases by adhesion at a plurality of positions. Furthermore, in the exemplary embodiment, simultaneously adhering at two surfaces facing each other makes it possible to offset stress caused by curing shrinkage. Thus, the exemplary embodiment is advantageous in preventing positional deviation of the plano-convex lens array 2 from an adjusted position.

### Fifth Exemplary Embodiment

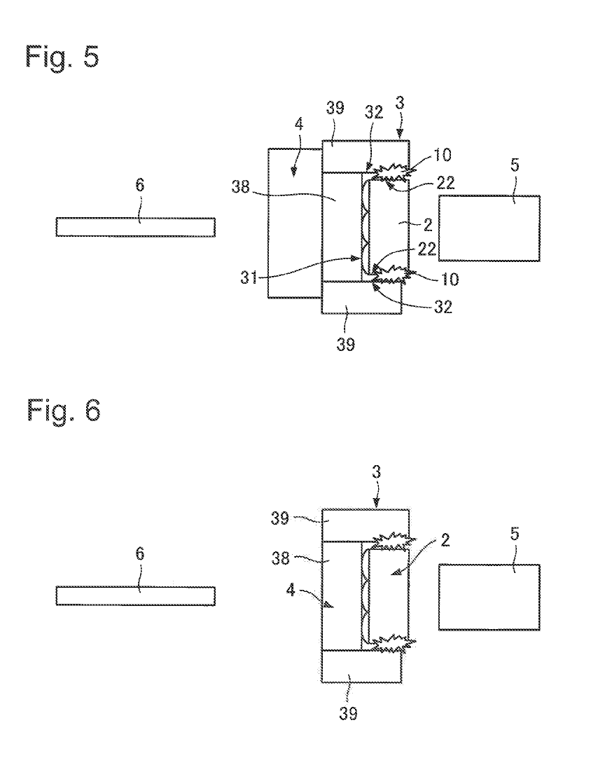

FIG. 5 is a diagram illustrating a configuration of a lens holder according to a fifth exemplary embodiment of the present invention. A difference between the configuration of the fifth exemplary embodiment illustrated in FIG. 5, and the configuration of the fourth exemplary embodiment illustrated in FIG. 4A and FIG. 4B resides in a polarizer 4, an optical element 5, and an optical fiber 6. The other configuration is the same as the configuration illustrated in FIG. 4A and FIG. 4B. Specifically, the fifth exemplary embodiment has a configuration, in which the polarizer 4 is adhered to the back side of a connection member 38 having one surface of a lens holding structure 3. In optically connecting the optical element 5 and the optical fiber 6 via a plano-convex lens array 2, a polarizer may be disposed on an optical path in order to compensate a polarization angle difference of signal light to be incident on the optical element 5. In this case, the distance between a plano-convex lens array and an optical element may be shortened depending on the numerical aperture of the optical element 5, and it may be difficult to secure a space capable of inserting a polarizer. Therefore, it is necessary to insert a polarizer between an optical fiber and a plano-convex lens array. In the exemplary embodiment, a polarizer is attached to a lens holding structure 3. This makes it possible to miniaturize an optical system, as compared with a configuration, in which a polarizer is fixed independently. Alternatively, a filter having a different function depending on characteristics for compensation may be adhered, in addition to a polarizer.

As described above, in an optical module including a polarizer, a lens holder is miniaturized. This makes it possible to alleviate constraints on the structural design of the optical module.

### Sixth Exemplary Embodiment

FIG. 6 is a side view illustrating a configuration of a lens holder according to a sixth exemplary embodiment of the present invention. A difference between the configuration of the sixth exemplary embodiment illustrated in FIG. 6, and the configuration of the fifth exemplary embodiment illustrated in FIG. 5 resides in a polarizer 4. The other configuration is the same as the configuration illustrated in FIG. 5. Specifically, the sixth exemplary embodiment has a configuration, in which the polarizer 4 is included in a connection member 38 having one surface 31 of a lens holding structure 3. The exemplary embodiment has an advantage that an optical system is further miniaturized, as compared with the fifth exemplary embodiment. It is needless to say that a lens holder can be constituted by not only a polarizer but also a filter having a different function for each light ray. Further, the other surface portion of the lens holding structure 3 may be made of a material different from the material for a filter.

As described above, in the exemplary embodiment, the lens holding structure 3 including a polarizer is further miniaturized. This is advantageous in alleviating constraints on the structural design.

### Seventh Exemplary Embodiment

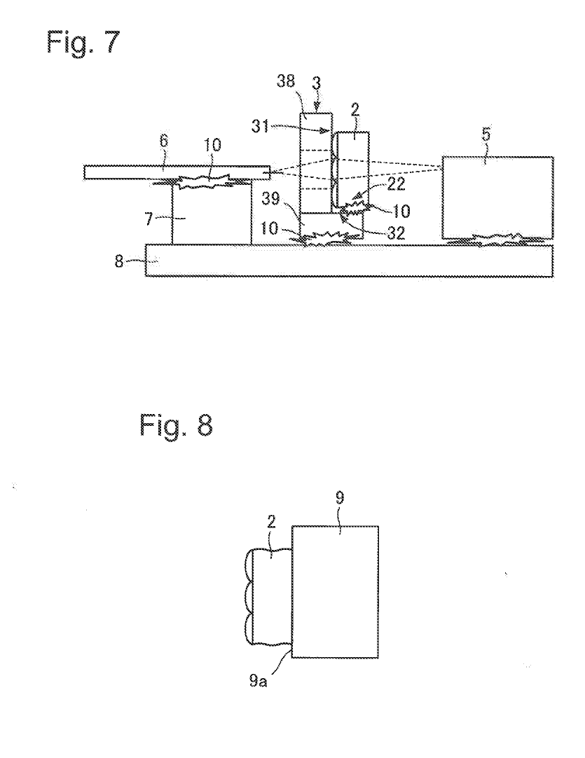

FIG. 7 is a diagram illustrating a configuration of an optical module according to a seventh exemplary embodiment of the present invention. The configuration of the seventh exemplary embodiment is a configuration, in which a lens holding structure 3, an optical element 5, an optical fiber 6, and an optical fiber holding component 7 are mounted on an optical component mounting carrier 8 by an adhesive agent 10, for instance. The optical element 5 and the optical fiber 6 are optically connected to each other via a plano-convex lens array 2. In other words, optical axes of the element 5, the optical fiber 6, and the plano-convex lens array 3 are disposed on a same straight line. Using the lens holding structure 3 makes it possible to hold a lens with an arbitrary orientation. This makes it possible to alleviate constraints on adjustment or the like in optical connection. Consequently, it is possible to remarkably reduce optical connection loss. An optical component mounting carrier and various components may be fixed by a method other than adhesion, such as welding, integral molding, or anodic bonding. The optical component mounting carrier may be an integrally formed carrier, or may be constituted by a plurality of carriers separated for each component to be mounted. Two or more lenses for optical connection may be used. In this case, at least one lens uses the lens holding structure 3, but the lenses other than the above may not use the lens holding structure 3.

As described above, it is possible to alleviate constraints on the structural design of an optical module.

### Eighth Exemplary Embodiment

Next, a minimum configuration required for alleviating constraints on the structural design of an optical module is described referring to FIG. 1. The plano-convex lens array 2 includes a plurality of lenses each having a convex surface. In the plano-convex lens array 2, optical axes of the lenses are disposed in parallel to each other. Further, the plano-convex lens array 2 is a lens array, in which the apex of the convex surface of each lens is included in a predetermined plane perpendicular to the optical axes of the lenses. A lens holding structure 3 in the exemplary embodiment includes one surface 31 which is brought into close contact with a plurality of the convex surfaces of the lens array, and another surface 32 for fixing a side surface of the lens array. This makes it possible to alleviate constraints on the structural design of an optical module.

The present invention is not limited to the exemplary embodiments.

Various modifications are applicable in the scope of the present invention defined in the claims. It is needless to say that the modifications are included in the scope of the present invention.

The invention of the present application is described as above referring to the exemplary embodiments. The invention of the present application, however, is not limited to the aforementioned exemplary embodiments. The configuration and the details of the invention of the present application may be modified in various ways comprehensible to a person skilled in the art in the scope of the invention of the present application.

This application claims the priority based on Japanese Patent Application No. 2014-035342 filed on Feb. 26, 2014, and all of the disclosure of which is hereby incorporated.

### REFERENCE SIGNS LIST

1 Lens holder

2 Plano-convex lens array

22 Side surface of plano-convex lens array

3 Lens holding structure

31 One surface of lens holding structure

32 Another surface of lens holding structure

33 Hole portion

4 Polarizer

5 Optical element

6 Optical fiber

7 Optical fiber holding component

8 Optical component mounting carrier

9 Plate member

10 Adhesive agent

1. A lens holding structure comprising:
with respect to a lens array including a plurality of lenses each having a convex surface, optical axes of the lenses being disposed in parallel to each other, the lenses being arranged in such a manner that an apex of the convex surface of each lens is included in a predetermined plane perpendicular to the optical axes of the lenses,
one surface which is brought into close contact with the convex surfaces of the lenses; and
another surface which fixes a side surface of the lens array.

2. The lens holding structure according to claim 1, wherein
the other surface and the side surface are fixed by using an adhesive agent.

3. The lens holding structure according to claim 1, wherein
the one surface and the convex surfaces are fixed by using an adhesive agent.

4. The lens holding structure according to claim 1, wherein
the one surface includes a hole portion.

5. The lens holding structure according to claim 1, wherein
the lens holding structure includes a plurality of the other surfaces.

6. The lens holding structure according to claim 1, further comprising a polarizer.

7. The lens holding structure according to claim 6, wherein
the polarizer is included in the one surface.

8. A lens holder comprising:
the lens holding structure according to claim 1;
and
the lens array.

9. An optical module comprising;
the lens holder according to claim 8;
an optical fiber which outputs or receives an optical signal; and
an optical element which outputs or receives the optical signal, and wherein the optical fiber and the optical element are optically connected by using the lens holder.

10. A lens holding method comprising:
with respect to a lens array including a plurality of lenses each having a convex surface, optical axes of the lenses being disposed in parallel to each other, the lenses being arranged in such a manner that an apex of the convex surface of each lens is included in a predetermined plane perpendicular to the optical axes of the lenses,
making close contact with the convex surfaces of the lenses; and
fixing a side surface of the lens array.
